(19) United States
(12) Patent Application Publication
(10) Pub. No.: US 2017/0220931 A1
(43) Pub. Date: Aug. 3, 2017

(54) METHOD AND DEVICE FOR MEASURING A SYSTEM TO BE TESTED

(71) Applicant: Robert Bosch GmbH, Stuttgart (DE)

(72) Inventor: Ernst Kloppenburg, Ditzingen (DE)

(21) Appl. No.: 15/408,557

(22) Filed: Jan. 18, 2017

(30) Foreign Application Priority Data
Feb. 2, 2016 (DE) 102016201559.1

(51) Int. Cl. G06N 5/02; G06F 17/50; G06N 99/00; G01M 15/02; G06N 7/00

(52) U.S. Cl. CPC G06N 5/02; G01M 15/02; G06N 7/005; G06N 99/005; G06F 17/5009

(57) ABSTRACT

A method for measuring a technical system, especially a combustion engine for a motor vehicle, using a number of measuring points to in each instance obtain a value of at least one output variable. The method includes selecting a measuring point from a quantity of measuring points, determining a confidence value for the selected measuring point on the basis of a classification model, the confidence value indicating a permissibility of an operating point that results owing to the operation of the technical system at the measuring point, measuring the technical system at the selected measuring point as a function of the confidence value, and updating the classification model, with an indication as to whether the operating point of the technical system set by the measurement of the selected measuring point is permissible.

### CROSS REFERENCE

The present application claims the benefit under 35 U.S.C. §119 of German Patent Application No. DE 102016201559.1 filed on Feb. 2, 2016, which is expressly incorporated herein by reference in its entirety.

### FIELD

The present invention relates to testing methods, and especially methods for providing measuring points with which a technical system to be tested is able to be tested. In particular, the present invention relates to methods for providing measuring points within system limits.

### BACKGROUND INFORMATION

When measuring a technical system with measuring points, it is necessary to set up the measuring points suitably in such a way that the greatest possible number of combinations of values of input variables in various excitation modes, that is, combinations of gradients of the input variables are measured, so that one obtains a space-filling and dynamics-filling occupancy of the input-data space with measuring points. The values of the output variable obtained during the measurement with respect to the measuring points may be used as training data for generating a data-based non-parametric functional model.

For the technical system to be modeled, e.g., a gasoline engine, it is especially important that the physical limitations of the technical system are not violated during the measurement, for example, on an engine test bench, in order to avoid damage to the technical system. In this context, during the measurement, the measuring method monitors the technical system to the effect that system-endangering combinations of values of the input variables are recognized prior to a damage to the unit.

In general, approaches which provide for generating all measuring points for the measurement in advance are disadvantageous, since they cannot reliably avoid system-critical operating states occurring unexpectedly.

### SUMMARY

According to the present invention, a method for measuring a technical system using a quantity of measuring points, as well as the corresponding device are provided.

According to a further aspect, an example method is provided to measure a technical system for generating a system model of the technical system, the measurement being carried out using a number of measuring points to in each instance obtain a value of at least one output variable. The method includes, e.g., the following steps:
Selecting a measuring point from a quantity of measuring points;
Determining a confidence value for the selected measuring point on the basis of a classification model, the confidence value indicating a modeled permissibility of an operating point that results owing to the operation of the technical system at the measuring point;
Measuring the technical system at the selected measuring point as a function of the confidence value; and
Updating the classification model, with an indication as to whether the operating point of the technical system set by the measurement of the selected measuring point is permissible.

In accordance with the present invention, from a quantity of measuring points provided, select measuring points are selected for measuring a technical system in such a way that the number of measuring processes at potentially system-endangering measuring points in the quantity of measuring points is minimized when measuring the technical system. To that end, according to the method above, the next measuring point to be measured in each case is selected as a function of a confidence value. The confidence value is ascertained according to a classification model as a model prediction or as a prognosis, and indicates a safety of the application of the corresponding measuring point to the technical system or a permissibility of the operating point of the technical system obtained owing to the measuring point. In this manner, upon determining that an impermissible measuring point results in response to the application of the measuring point for an actual measurement, a classification model may gradually be refined. The classification model may indicate a confidence value for further measuring points, as a function of which, further measuring points from the quantity of measuring points are excluded from the measurement, so that the safety of the measurement of the technical system is increased in so far as the number of measuring processes at impermissible measuring points is reduced. Thus, endangerment of the technical system by the measurement is able to be minimized or ruled out.

Moreover, the measuring points may be selected from the quantity of measuring points according to an increasing distance from a preset starting measuring point.

In particular, the starting measuring point may be determined as a function of a geometric mean of the value ranges of several or all input variables of the measuring points, or may be specified as a measuring point at which the technical system is operable with a permissible operating point.

The classification model may be generated by a k-nearest-neighbor method, a variable kernel density estimation method, an SVM (support vector machines) method or a Gaussian-process classification algorithm.

According to a further specific embodiment, the classification model may be updated for each measured measuring point with the indication as to whether the operating point determined by the selected measuring point is permissible.

Moreover, it may be provided to measure a measuring point only if all points of a direct connecting line between a preset starting measuring point and the selected measuring point through the input-variable space are assigned confidence values that are in keeping with the classification model and in each case have a degree of permissibility above a specified threshold permissibility.

It may be provided to measure the technical system at the selected measuring point only if the confidence value indicates that the operation of the technical system at the operating point determined by the measuring point is permissible.

According to one specific embodiment, the measuring points may be selected from a quantity of measuring points by grouping the measuring points according to working points of the technical system, and for each of the working points, selecting the measuring points one after another from the quantity of measuring points in accordance with an increasing distance from a starting measuring point assigned to the one working point. In this way, hopping between working points, which may be given in the case of a combustion engine, especially owing to its RPM, may be avoided.

According to a further aspect, a device, particularly an arithmetic logic unit, is provided, which is designed to carry out the method above.

### BRIEF DESCRIPTION OF THE DRAWINGS

Specific embodiments are explained in greater detail below on the basis of the figures.

FIG. 1 shows a representation of a test system for measuring a technical system.

FIG. 2 shows a flow chart to illustrate a method for measuring a technical system using selected measuring points.

FIG. 3 shows a representation of a sequence of measuring points for a two-dimensional input space.

### DETAILED DESCRIPTION OF EXAMPLE EMBODIMENTS

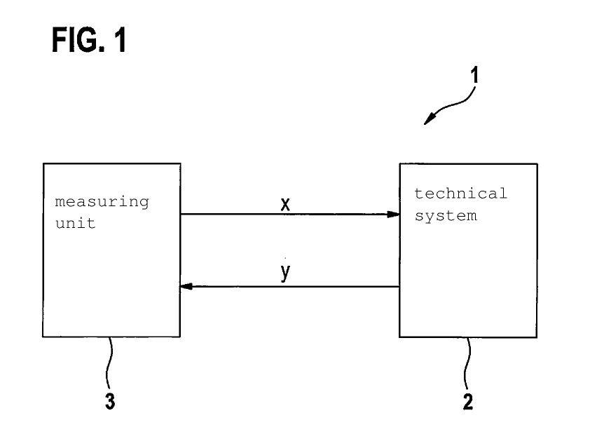

FIG. 1 shows a schematic representation of a test or inspection system 1, which is designed to measure a technical system 2. For example, a technical system 2 may be a combustion engine of a motor vehicle or a subsystem of it. A measuring unit 3 controls technical system 2 with a sequence of measuring points X that lead to specific operating points of technical system 2. However, as a rule, measuring points X include a number d of a plurality of input variables which are combined in one input-variable vector X [symbol] R^{d} and thus form one measuring point x. In addition, one permissible value range is valid for each of the d input variables. Furthermore, the control of technical system 2 results in one or more output variables y, which are measured at measuring points X.

For the complete measurement of technical system 2, generally, measuring points X are varied over a large range within the permissible value ranges, to thus achieve the greatest possible space-filling occupancy of the input-data space by the measuring points.

The measuring points, together with the correspondingly associated values of the output variable, form data points Dᵢ=(y,X), with outputs y [symbol] Rⁱ with respect to input points X [symbol] R^{i×d}.

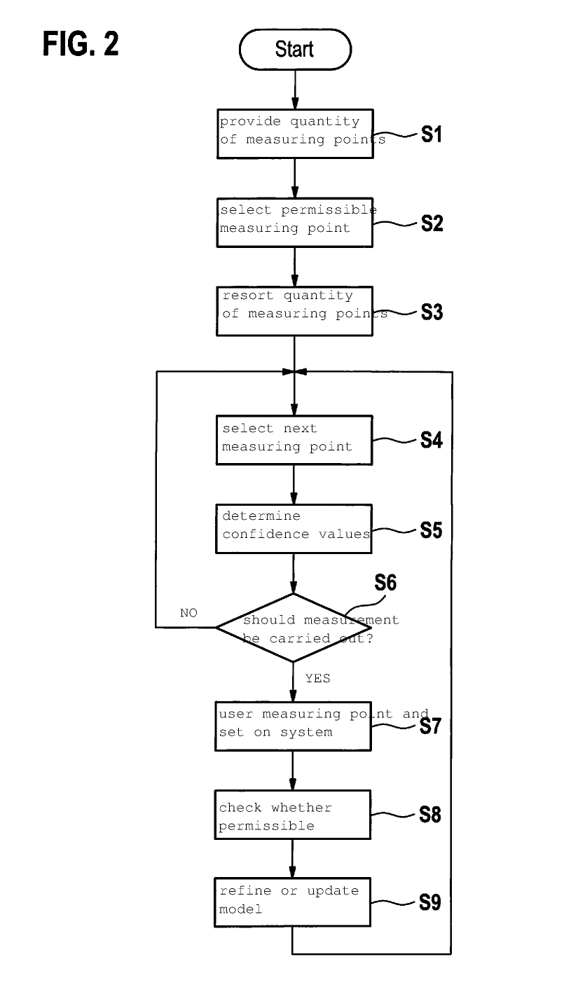

FIG. 2 shows a flow chart to illustrate a method for measuring a technical system.

In step S1, a quantity of measuring points is provided which, in as space-filling manner as possible, occupy the input-data space that may be defined by the permitted value ranges of the input variables.

Subsequently in step S2, from the quantity of measuring points provided, a permissible measuring point is selected as starting measuring point, or a starting measuring point is specified independently of the measuring points provided. The starting point may be preset manually by a test-bench expert, or ascertained by calculation from the quantity of measuring points. For example, that measuring point may be selected as starting measuring point which has the least distance to a geometric center of the input-data space. Alternatively, the geometric center of the input-data space may also be specified as starting measuring point.

Alternatively, for one or more of the input variables, a boundary value or any other predetermined value may be assumed as part of the starting measuring point, and the geometric center of the remaining input-data space, which is determined by the remaining input variables, may be defined in order to ascertain the starting measuring point from the geometric center of the remaining input-data space and the predetermined values of the one or more input variables. In particular, this may be useful in the case of a combustion engine as technical system like, for example, when using the camshaft position as input variable or the like.

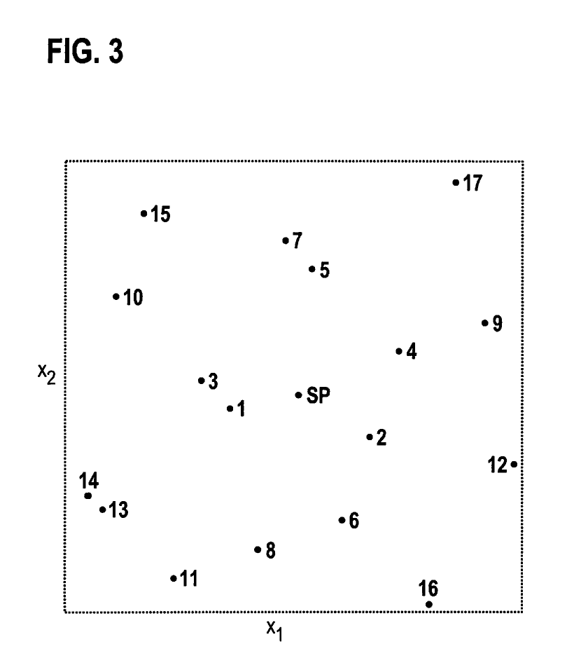

In step S3, the quantity of measuring points is now resorted as a function of the permissible starting measuring point. In so doing, one sorting criterion may be an increasing distance from starting measuring point SP. For example, in FIG. 3 in the case of a 2-D measuring-point space with input variables x1, x2, the measuring sequence of measuring points is represented by the increasing distance from starting measuring point SP.

In step S4, a first or a next measuring point is now selected from the quantity of sorted measuring points.

In order to avoid a rapid abrupt change between working points, the measuring points may be selected from the quantity of measuring points by grouping the measuring points according to working points of the technical system, and for each of the working points, selecting the measuring points one after another from the quantity of measuring points according to an increasing distance from a starting measuring point assigned to the one working point. In this manner, technical system 2 is first measured with the measuring points at one working point, and subsequently a next working point is selected for the measurement. For example, in the case of a combustion engine as technical system, the working point may be predetermined by load and engine speed.

In step S5, a confidence value is determined for the measuring point in question based on a classification model. The classification model supplies the confidence value as a model variable for each measuring point as a degree of the actual or prognosticated permissibility of applying the measuring point in question to the technical system, that is, the confidence value indicates to what extent (with what probability) according to the classification model it is to be anticipated or is able to be forecast, that a permissible or allowed system response will occur upon applying the measuring point in question to technical system 2. The permissibility of the measuring point is thus determined by the fact that the response of the technical system satisfies predetermined conditions, e.g., with regard to adjustability of a steady-state operating point (no oscillation), with regard to value limits for state variables or the like.

In order to discard as many non-permissible measuring points as possible, that is, measuring points recognized as non-permissible as model prediction of the classification model, in step S6, with the aid of the classification model, which is gradually rendered more precisely, it is decided for the measuring point selected in step S4, whether the measurement should actually be carried out. To that end, a threshold-value comparison may be carried out with a predefined confidence threshold value, so that the technical system is measured at the selected measuring point only if the confidence value of the selected measuring point indicates a degree of permissibility above the predefined confidence threshold value.

If it is determined that the necessary degree of permissibility of the measuring point is not achieved (alternative: no), then the method jumps back to step S4 and a next measuring point is selected from the quantity of sorted measuring points. Otherwise, (alternative: yes), in step S7, the measuring point is used and set accordingly on the technical system.

In step S8, it is checked whether the resulting output variable lies in a permissible or impermissible range, or whether a permissible or impermissible system behavior, determinable in some other way, is present.

In step S9, the classification model is refined or updated based on the result of the measurement of the measuring point in question.

In other words, the permissibility of the measuring point may now be determined on the basis of one or more resultant output variables or system parameters, and the information as to whether or not the measuring point in question is permissible may be used to refine the classification model.

Various algorithms from the area of machine learning may be used as classification algorithm for generating the classification model. The classification algorithm is preferably selected so that with a high number of input variables, especially more than five, it is already usable with a very small number of measuring points. In addition, after a measurement of a correspondingly next selected measuring point, the classification algorithm should be able to be updated within a brief time, that is, with little computing expenditure. Furthermore, the classificator should provide a continuous confidence value that, in particular, may assume a value range between 0 and 1. In this context, “0” may indicate a non-permissible measuring point, and “1” a permissible measuring point.

Possible classification algorithms may be a k-nearest-neighbor method, a variable kernel density estimation method, an SVM method (SVM: support vector machines), a Gaussian-process classification algorithm and the like. These classification algorithms allow for being refined based on a measuring point and an indication as to whether the application of the measuring point to the technical system has led to a permissible or impermissible system state.

The method subsequently jumps back to step S4, and a next measuring point is selected from the quantity of sorted measuring points.

In order to ensure that a next selected measuring point lies in a permissibility range of the measuring points, in step S6, it may additionally be provided that the next measuring point is selected only if a direct connection between the starting measuring point and the selected measuring point does not pass through an area of measuring points which the classificator would evaluate as impermissible. To that end, a connecting line between starting measuring point SP and the selected measuring point may be subdivided into sections, and corresponding confidence values may be determined in accordance with the existing classification model along the connecting line. The confidence values thus ascertained are evaluated in accordance with the confidence threshold value. If it is thereby determined for at least one of the confidence values thus ascertained, that the degree of permissibility is not attained, then it may be provided to discard the selected measuring point. In other words, a measuring point may only be measured if all points of a direct connecting line between a preset starting measuring point and the selected measuring point through the input-variable space are assigned confidence values that are in keeping with the classification model and in each case have a degree of permissibility above a predefined threshold permissibility. The next measuring point may subsequently be selected by a return to step S4.

In the case of a combustion engine as technical system, which is to be measured on test bench 1, permissibility or non-permissibility of a measuring point may be determined by the operability of the combustion engine. Further criteria may be the fuel consumption, the emission of pollutants or the like. In any case, the corresponding degree of permissibility must be obtainable by evaluation of the output variable determined by a measurement of a measuring point.

What is claimed is:

1. A method for measuring a technical system for generating a system model of the technical system, the measurement being carried out using a number of measuring points to in each instance obtain a value of at least one output variable, the method comprising:
selecting a measuring point from a quantity of measuring points;
determining a confidence value for the selected measuring point on the basis of a classification model, the confidence value indicating a modeled permissibility of an operating point that results owing to an operation of the technical system at the measuring point;
measuring the technical system at the selected measuring point as a function of the confidence value; and
updating the classification model with an indication as to whether the operating point of the technical system set by the measurement of the selected measuring point is permissible.

2. The method as recited in claim 1, wherein the technical system is a combustion engine for a motor vehicle.

3. The method as recited in claim 1, wherein the measuring points are selected one after another from the quantity of measuring points according to an increasing distance from a preset starting measuring point.

4. The method as recited in claim 3, wherein the starting measuring point is one of: i) determined as a function of a geometric mean of value ranges of several or all input variables of the measuring points, or ii) is specified as a measuring point at which the technical system is operable with a permissible operating point.

5. The method as recited in claim 1, wherein the classification model is generated by a k-nearest-neighbor method, a variable kernel density estimation method, an SVM method or a Gaussian-process classification algorithm.

6. The method as recited in claim 1, wherein the classification model is updated for each measured measuring point, with the indication as to whether the operating point determined by the selected measuring point is permissible.

7. The method as recited in claim 1, wherein a measuring point is measured only if all points of a direct connecting line between a preset starting measuring point and the selected measuring point through the input-variable space are assigned confidence values that are in keeping with the classification model and in each case have a degree of permissibility above a specified threshold permissibility.

8. The method as recited in claim 1, wherein the technical system is measured at the selected measuring point only if the confidence value indicates that the operation of the technical system at the operating point determined by the measuring point is permissible.

9. The method as recited in claim 1, wherein measurement of the technical system at the selected measuring point is blocked if the confidence value indicates that the operation of the technical system at the operating point determined by the measuring point is impermissible.

10. The method as recited in claim 1, wherein the measuring points are selected from a quantity of measuring points by:
grouping the measuring points according to working points of the technical system, and, for each of the working points, selecting the measuring points one after another from the quantity of measuring points in accordance with an increasing distance from a starting measuring point assigned to the one working point.

11. An arithmetic logic unit designed to measure a technical system for generating a system model of the technical system, the measurement being carried out using a number of measuring points to in each instance obtain a value of at least one output variable, the arithmetic logic unit designed to:
select a measuring point from a quantity of measuring points;
determine a confidence value for the selected measuring point on the basis of a classification model, the confidence value indicating a modeled permissibility of an operating point that results owing to an operation of the technical system at the measuring point;
measure the technical system at the selected measuring point as a function of the confidence value; and
update the classification model with an indication as to whether the operating point of the technical system set by the measurement of the selected measuring point is permissible.

12. A non-transitory machine-readable storage medium on which is stored a computer program for measuring a technical system for generating a system model of the technical system, the measurement being carried out using a number of measuring points to in each instance obtain a value of at least one output variable, the computer program, when executed by a processor, causing the processor to perform:
selecting a measuring point from a quantity of measuring points;
determining a confidence value for the selected measuring point on the basis of a classification model, the confidence value indicating a modeled permissibility of an operating point that results owing to an operation of the technical system at the measuring point;
measuring the technical system at the selected measuring point as a function of the confidence value; and
updating the classification model with an indication as to whether the operating point of the technical system set by the measurement of the selected measuring point is permissible.
